(19) United States
(12) Patent Application Publication
(10) Pub. No.: US 2022/0045830 A1
(43) Pub. Date: Feb. 10, 2022

(54) USER APPARATUS

(71) Applicant: NTT DOCOMO, INC., Tokyo (JP)

(72) Inventors: Ryosuke Osawa, Chiyoda-ku, Tokyo (JP); Huan Wang, Beijing, Haidian District (CN); Xufei Zheng, Beijing, Haidian District (CN); Xiaolin Hou, Beijing, Haidian District, (CN); Xinxin He, Beijing, Haidian District (CN); Jie Lv, Beijing, Haidian District (CN); Jiaqi Zhao, Beijing, Haidian District (CN); Tao Luo, Beijing, Haidian District (CN)

(73) Assignee: NTT DOCOMO, INC., Tokyo (JP)

(21) Appl. No.: 17/281,349

(22) PCT Filed: Oct. 3, 2018
(86) PCT No.: PCT/JP2018/037106

§ 371 Date: Mar. 30, 2021

(51) Int. Cl. H04L 5/00; H04W 72/08

(52) U.S. Cl. CPC H04L 5/0073; H04L 5/0062; H04L 5/0066; H04W 72/085

(57) ABSTRACT

A user apparatus includes: a receiver configured to perform predetermined measurement for a resource set in direct communication between terminals, the resource set having a likelihood of being used by another group to which the user apparatus does not belong; a control unit configured to determine, based on a result of the predetermined measurement, whether an effect from said another group having a likelihood of using the resource set is acceptable; and a transmitter configured to use the resource set to perform transmission to another user apparatus when a determination is made that the effect from said another group that uses the resource set is acceptable.

### TECHNICAL FIELD

The present invention relates to a user apparatus in a radio communication system.

### BACKGROUND ART

In LTE (Long Term Evolution) and succeeding systems of LTE (e.g., LTE-A (LTE-Advanced), NR (New Radio) (also referred to as 5G)), D2D (Device to Device) technology has been considered for executing direct communication between user apparatuses without an intervening base station apparatus (see, for example, Non-patent document 1).

D2D reduces traffic between user apparatuses and base station apparatuses, and enables communication between user apparatuses when base station apparatuses become incapable of executing communication in the event of a disaster or the like. Note that although D2D is referred to as “sidelink” in the 3GPP (3rd Generation Partnership Project), a more general term D2D is used in the present specification. However, “sidelink” may also be used as necessary in the description of embodiments, which will be described later.

D2D communication is generally classified into D2D discovery to find another user terminal that is ready to communicate, and D2D communication for direct communication between terminals (also referred to as D2D direct communication, D2D communication, direct communication between terminals, etc.). In the following, when D2D communication, D2D discovery, and the like are not distinguished in particular, these may be simply referred to as D2D. Also, a signal transmitted and received in D2D will be referred to as a D2D signal. Various use cases of services related to V2X (Vehicle to Everything) in NR have been considered (e.g., Non-Patent Document 2).

### RELATED ART DOCUMENT

### Non-Patent Document

NON-PATENT DOCUMENT 1: 3GPP TS 36.211 V15.2.0(2018-06)
NON-PATENT DOCUMENT 2: 3GPP TR 22.886 V15.1.0(2017-03)

### SUMMARY OF THE INVENTION

### Problem to be Solved by the Invention

In the direct communication between terminals in V2X, there may be a case where user apparatuses constitute a group to use resources associated with the group. It is not clear whether a certain group can use resources used by another group.

The present invention has been made in view of the above, and has an object to determine whether or not resources can be used in direct communication between terminals to perform efficient communication.

### Means for Solving the Problem

According to the disclosed technology, a user apparatus is provided that includes a receiver configured to perform predetermined measurement for a resource set in direct communication between terminals, the resource set having a likelihood of being used by another group to which the user apparatus does not belong; a control unit configured to determine, based on a result of the predetermined measurement, whether an effect from said another group having a likelihood of using the resource set is acceptable; and a transmitter configured to use the resource set to perform transmission to another user apparatus when a determination is made that the effect from said another group that uses the resource set is acceptable.

### Effect of the Present Invention

According to the disclosed technology, it is possible to determine whether or not resources are available and to perform efficient communication in direct communication between terminals.

### BRIEF DESCRIPTION OF THE DRAWINGS

FIG. 1 is a diagram for describing V2X;

FIG. 2 is a diagram for describing an example (1) of a radio communication system according to an embodiment of the present invention;

FIG. 3 is a diagram for describing an example (2) of a radio communication system according to an embodiment of the present invention;

FIG. 4 is a diagram for describing an example of a reusable resource set in an embodiment according to the present invention;

FIG. 5 is a diagram for describing a determination example of a sensing result of a resource set according to an embodiment of the present invention;

FIG. 6 is a flowchart for describing an example of operations of selecting a resource set according to an embodiment of the present invention;

FIG. 7 is a diagram illustrating an example of a functional configuration of a base station apparatus 10 according to an embodiment of the present invention;

FIG. 8 is a diagram illustrating an example of a functional configuration of a user apparatus 20 according to an embodiment of the present invention; and

FIG. 9 is a diagram illustrating an example of a hardware configuration of the base station apparatus 10 or the user apparatus 20 according to an embodiment of the present invention.

### EMBODIMENTS FOR CARRYING OUT THE INVENTION

In the following, embodiments of the present invention will be described with reference to the drawings. Note that an embodiment described below merely presents an example, and an embodiment to which the present invention is applied is not limited to the following embodiment.

When operating a radio communication system of an embodiment of the present invention, existing technologies may be used appropriately. Here, the existing technique may be, for example, an existing LTE, but is not limited to the existing LTE. Also, the term “LTE” used in the present specification, unless otherwise stated, has a broad meaning that includes methods of LTE-Advanced, those subsequent to LTE-Advanced (e.g., NR), and wireless LANs (Local Area Network).

In an embodiment of the present invention, the duplex method may be a TDD (Time Division Duplex) method, an FDD (Frequency Division Duplex) method, or any other method (e.g., Flexible Duplex, etc.).

Also, in an embodiment of the present invention, stating that a radio parameter or the like is set (configured) may mean that a predetermined value is set in advance (pre-configured), or that a radio parameter indicated by a base station apparatus 10 or a user apparatus 20 is set.

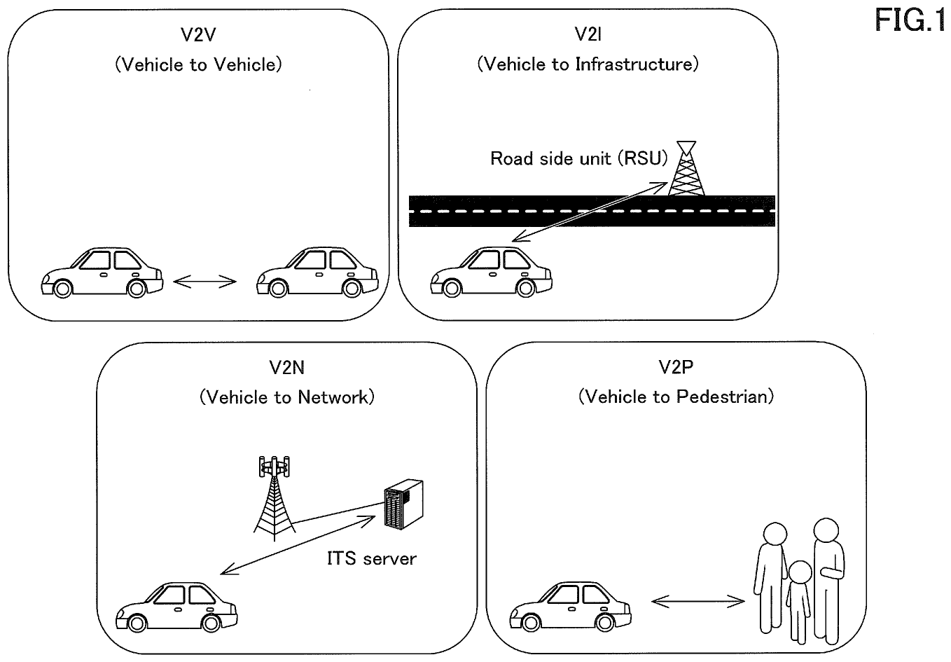

FIG. 1 is a diagram for describing V2X. In the 3GPP, implementation of V2X (Vehicle to Everything) or eV2X (enhanced V2X) has been considered by extending the D2D functions, for further development as a technical specification. As illustrated in FIG. 1, V2X is a part of ITS (Intelligent Transport Systems), which is a generic term of V2V (Vehicle to Vehicle) meaning a form of communication executed between vehicles; V2I (Vehicle to Infrastructure) meaning a form of communication executed between a vehicle and a roadside unit (RSU); V2N (Vehicle to Network) meaning a form of communication executed between a vehicle and an ITS server; and V2P (Vehicle to Pedestrian) meaning a form of communication executed between a vehicle and a mobile terminal carried by a pedestrian.

Also, in the 3GPP, V2X that uses cellular communication and communication between terminals of LTE or NR has been considered. V2X using cellular communication is also referred to as cellular V2X. In V2X of NR, studies are underway to implement high capacity, low latency, high reliability, and QoS (quality of service) control.

In the future, V2X of LTE or NR may be studied in a way not limited by the 3GPP specifications. For example, studies may take place in ensuring interoperability; lowering the cost by implementing a higher layer; combining or switching multiple RAT (Radio Access Technologies); consideration for regulations in respective countries; obtaining and delivering data on V2X platforms of LTE or NR; database management; and use methods.

In embodiments of the present invention, although a form of a communication device installed on a vehicle is mainly assumed, the embodiments of the present invention are not limited to the form. For example, the communication device may be a terminal carried by a person; the communication device may be a device installed on a drone or an airplane; or the communication device may be a base station, an RSU, a relay node, or a user apparatus having scheduling capability.

Note that SL (sidelink) may be distinguished as either UL (uplink) or DL (downlink), which may be combined with one of or a combination of the following 1) to 4). Also, SL may be replaced with another term.

1) Resource arrangement in the time domain
2) Resource arrangement in the frequency domain
3) Reference synchronization signal (including SLSS (Sidelink Synchronization Signal)
4) Reference signal used for path loss measurement for controlling transmission power

Also, for OFDM (Orthogonal Frequency Division Multiplexing) of SL or UL, one of CP-OFDM (Cyclic-Prefix OFDM), DFT-S-OFDM (Discrete Fourier Transform-Spread-OFDM), OFDM without transform precoding, and OFDM with transform precoding may be applied.

In SL of LTE, Mode 3 and Mode 4 are specified for resource allocation of SL to a user apparatus 20. In Mode 3, transmission resources are dynamically allocated by DCI (Downlink Control Information) transmitted from a base station apparatus 10 to a user apparatus 20. Further, in Mode 3, SPS (Semi-Persistent Scheduling) is also possible. In Mode 4, a user apparatus 20 autonomously selects transmission resources from a resource pool.

Note that a slot in an embodiment of the present invention may be read as a symbol, a mini slot, a subframe, a wireless frame, or a TTI (Transmission Time Interval). Also, a cell in an embodiment of the present invention may be read as a cell group, a carrier component, a BWP, a resource pool, a resource, RAT (Radio Access Technology), a system (including a wireless LAN), or the like.

In general, there are three types of MAC (Media Access Control) configurations for ad-hoc networks such as V2X, which are distributed type, semi-distributed type, and centralized type. In the centralized-type MAC, resource allocation is performed by a base station apparatus 10 as a coordinator/manager. For example, LTE Sidelink Transmission mode-3 or the like corresponds to the centralized MAC. A disadvantage of the central control MAC is that the central control MAC is not operational outside of the coverage, for example. In addition, a base station apparatus 10 is affected such that overhead due to SR (Scheduling Requests) and BSR (Buffer Status Reports) becomes excessive. For example, if a large number of UE-installed vehicles transmit SR and BSR, the network needs to support a low-latency SR procedure because a large overhead is expected.

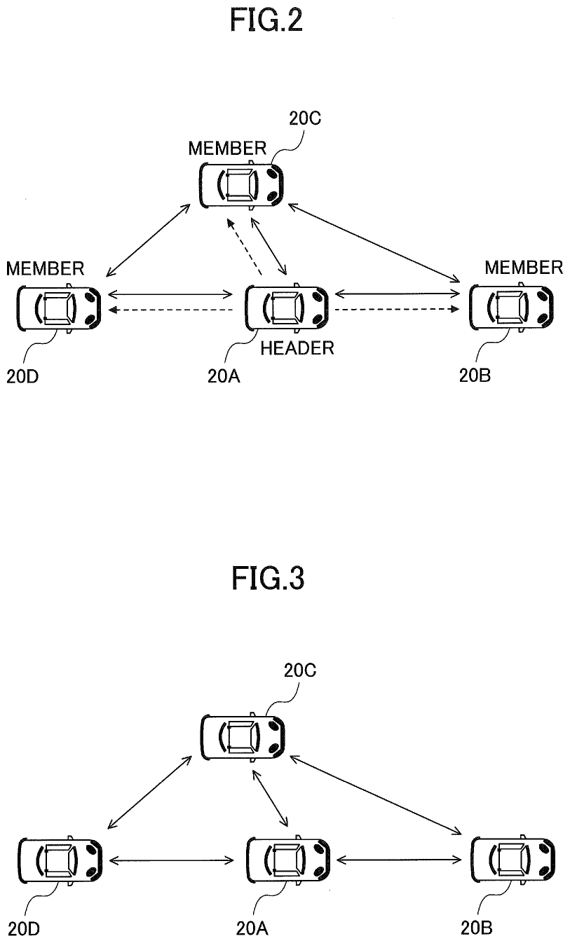

FIG. 2 is a diagram for describing an example (1) of a radio communication system. The radio communication system illustrated in FIG. 2 is an example of a configuration of the semi-distributed-type MAC, in which a group is constituted with at least one user apparatus 20 as the header and one or more user apparatuses 20 as members. In the example in FIG. 2, there exists a UE group that includes four user apparatuses 20 constituted with a user apparatus 20A as the header; and a user apparatus 20B, a user apparatus 20C, and a user apparatus 20D as the members. In the semi-distributed-type MAC, resource allocation or scheduling is performed by the user apparatus 20A as the coordinator/manager. In the semi-distributed-type MAC, multiple user apparatuses 20 are divided into a UE group constituted with one or more user apparatuses 20, and SL resource allocation or scheduling is performed by the user apparatus 20 as the header of the UE group, for the user apparatuses 20 as the members. Such scheduling of the semi-distributed-type MAC can resolve the disadvantage of the distributed-type MAC or the centralized-type MAC described above. The header is a user apparatus 20 in a UE group constituted with multiple user apparatuses 20 that allocates or schedules resources, which are to be used in direct communication between terminals within a resource set associated with the UE group, to other user apparatuses 20. The member is a user apparatus 20 in a UE group constituted with multiple user apparatuses 20 that is allocated or scheduled with resources to be used in direct communication between terminals, from a user apparatus 20 as the header.

FIG. 3 is a diagram for describing an example (2) of a radio communication system. The radio communication system illustrated in FIG. 3 is an example of the distributed-type configuration in which a group is constituted with one or more user apparatuses 20 as the members. In the example in FIG. 2, there exists a UE group that includes four user apparatuses 20 constituted with a user apparatus 20A, a user apparatus 20B, a user apparatus 20C, and a user apparatus 20D. In the distributed-type MAC, there is no coordinator/manager that performs resource allocation or scheduling. Each user apparatus 20 autonomously selects SL resources used by the apparatus itself for transmission. For example, 802.11p, LTE Sidelink Transmission mode 4, or the like corresponds to the distributed-type MAC. Disadvantages of the distributed-type MAC include, for example, as follows. Mode 4 assumes cyclic traffic and is not suitable for non-cyclic traffic. In 802.11p that uses CSMA (Carrier Sense Multiple Access), many resource conflicts occur, and in situations where there are a large number of terminals, requirements of high reliability cannot be satisfied.

Here, since it is not clear whether a resource set used by a certain UE group can be reused in another UE group, it has been difficult to improve the use efficiency of the resources. Therefore, a method is proposed for determining conditions under which a resource set can be reused, to reuse the resource set. Here, “reusing resources” means that radio resources in the same frequency domain or time domain are used by different user apparatuses or UE groups. In the following, a “resource set” may be replaced with “resources”. Also, in the following, an operation performed by a “UE group” may be performed by the header of the UE group, may be performed by a member of the UE group, or may be performed by a user apparatus 20 included in a distributed-type UE group.

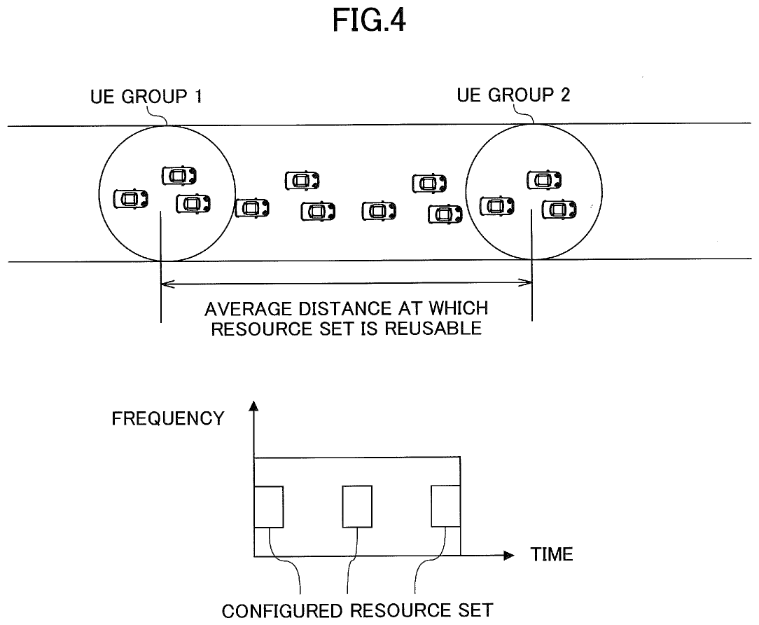

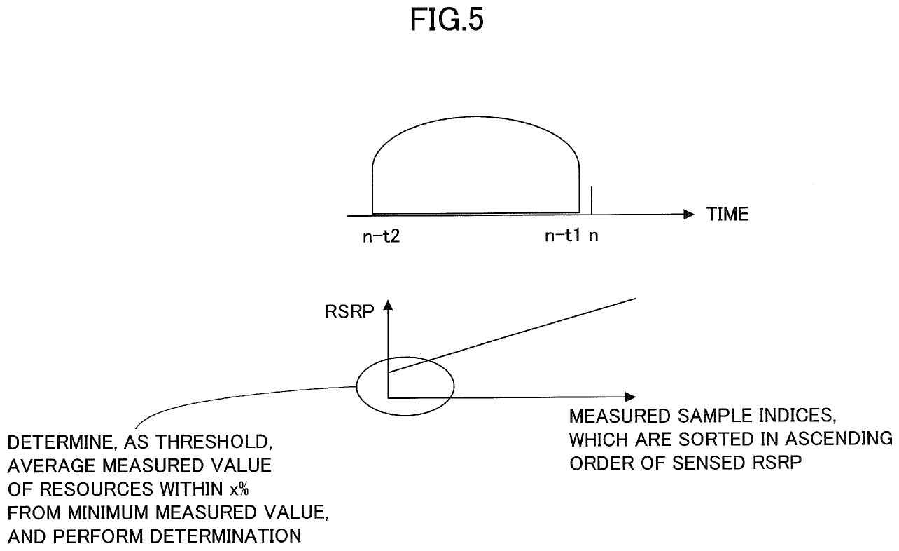

FIG. 4 is a diagram for describing an example of a reusable resource set in an embodiment of the present invention. The distance between UE groups using the same resource set should be set to at least an average reusable distance to avoid interference between the UE groups. When a UE group selects a resource set used for transmission, a resource set used by another UE group existing at a position that exceeds the average reusable distance may be selected. Therefore, as a condition for a UE group to select a resource set, it may be specified that one or more UE group using the resource set exists at a position that exceeds the average reusable distance.

In a situation where a UE Group 1 and a UE Group 2 using the same resource set are close to each other as illustrated in FIG. 4, if the above-described sensing detects that the resource set to be used is being reused by the other UE group in the proximity, the UE Group 1 or the UE Group 2 may reselect a resource set. In addition, as a condition for reselecting a resource set, a determination may be made by adding an offset value to a threshold that determines the average reusable distance. The absolute value of the offset may be increased or decreased as the reselection is repeated. The UE Group may also reselect a resource set upon detecting that a resource set is being reused in another UE group consecutively within a predetermined period or for a predetermined number of times. Setting the offset value and/or the period or the number of times of detection enables to avoid repeated reselection of the resource set within a short period of time. For example, the offset value may be set based on geographic positional information between the UE groups.

FIG. 5 is a diagram for describing an example of determining a result of sensing or measurement (referred to as “sensing”, below) of a resource set in an embodiment of the present invention. Here, “sensing” means predetermined measurement, which may be, for example, RSRP (Reference Signal Received Power) measurement, RSRQ (Reference Signal Received Quality) measurement, SINR (Signal to Noise plus Interference Ratio) measurement, CBR (Channel busy ratio) measurement, or the like. Based on a result of sensing, a user apparatus 20 in a UE group determines whether a resource set having a likelihood of being used by another UE group is a reusable resource set acceptable in terms of an influence caused by the other UE group; in other words, determines whether the other UE group does not exist within the average reusable distance at which the resource set is reusable.

As illustrated in FIG. 5 where n represents the current time, a time window is set from n-t2 to n-t1 (t2<t1). A user apparatus 20 performs sensing for the time window to determine whether the resource set is reusable. At least one of t1 and t2 may be set or specified, and n may also be the time at which the resource set is selected. If having determined that it is a reusable resource set, the user apparatus 20 may perform transmission to other user apparatuses 20 by using the resource set.

As illustrated in FIG. 5, in the time window [n-t2, n-t1], an average value of resources within x % from a minimum value of sensed RSRP or the like sorted in ascending order or a maximum value sorted in descending order may be set as a threshold used when determining a reusable resource set. For example, a measurement result of sensing is sorted in ascending order in the case of RSRP, or sorted in descending order in the case of RSRQ or SINR. The above threshold may be a discretized value. For example, a range of the above threshold that can be set may be specified with discretized step values. The value of x % may also be set or specified. For example, x % may be 10% or may be 20%. Also, the sampling rate for measuring RSRP or the like can be set discretionarily. For example, the time window may be set to 1 s and the sampling rate may be set to 1 ms. For example, if the time window is set to 1 s, the sampling rate is set to 1 ms, and the x % is 10%, then, from among 1000 samples of sensed values, 100 samples of the sensed values that are small in value or 100 samples that are great in value are averaged.

The above sensing performed for threshold determination may be performed based on RSRP measurement of DMRS (Demodulation reference signal), SLSS (Sidelink synchronization signal), AGC (Auto gain control) symbol, sensing reference signal, or any other reference signal transmitted from a user apparatus 20 that is multiplexed or associated with the target resource set, or that uses resources, or from a user apparatus 20 that belongs to a UE group. RSRP measurement may be replaced with RSSI (Received Signal Strength Indicator), RSRQ, or SINR measurement.

The user apparatus 20 may determine whether or not the UE group associated with the resource set exists at a position sufficiently separated to be reusable, based on whether or not the result of the sensing of the resource set described above is over or below the threshold; namely, to determine that the resource set is reusable. A UE group using a resource set “exists at a position sufficiently separated to be reusable” is the same as “RSRP is below the threshold” or “RSRQ or SINR is above the threshold” as a result of the sensing of the resource set described above. The determination may be executed for each resource pool, for each resource set, for each carrier, for each band, or for each BWP (Bandwidth Part).

Also, GNSS (Global Navigation Satellite System) signals obtained by the user apparatus 20 and/or positional information obtained from the GNSS signals may be reported to the base station apparatus 10, to measure the distance between the user apparatuses 20 or between the UE groups based on the positional information of the user apparatuses 20 or the UE groups summed up by the base station apparatus 10, or a distance may be used as the threshold. The UE group positional information may be calculated based on the positional information of one or more user apparatuses 20 among the user apparatus 20 serving as the header belonging to the UE group and the other user apparatuses 20 serving as members of the UE group, and the UE group positional information may be an average value. Also, the positional information may be exchanged directly between the user apparatuses 20 or between the UE groups to calculate the distance in each of the user apparatuses 20 or the UE groups. Also, the following methods 1) to 3) may be used as a method for obtaining the distance between the user apparatuses 20 or between the UE groups, instead of the method based on the GNSS information described above.

1) Distance obtained from the position of a base station apparatus 10 to which a user apparatus 20 or UE group belongs, and the position of a base station apparatus 10 to which another user apparatus 20 or UE group belongs. In the case of small cells having relatively small cell radii, the distance can be calculated with relatively high accuracy.
2) Distance between a user apparatus 20 and a base station apparatus 10 calculated based on the time required for a one-way or round-trip signal transmitted and received between the user apparatus 20 and the base station apparatus 10. For example, the time required for the one-way or round-trip signal transmitted and received between the user apparatus 20 and the base station apparatus 10 may be a transmission timing correction value obtained with a TA (Timing Advance) command, or the time required for receiving a PRACH response from a PRACH (Physical Random Access Channel) preamble transmission time.
3) Distance between a user apparatus 20 and a base station apparatus 10 obtained from cell IDs and numerical values obtained by converting RSRP or RSRP to a distance. For example, the distance may be calculated based on the amount of attenuation calculated from the transmission power and the value of RSRP.

An offset value may be added to the above threshold to determine the reusability of the resources described above to determine the final threshold. A candidate of the offset value may be set or may be specified in advance. For example, the offset value may be zero, a positive value, or a negative value. The offset value may be indicated by a base station apparatus or a user apparatus. Any signal among SCI (Sidelink Control Information)/DCI (Downlink Control Information), MAC, and RRC (Radio Resource Control) may be used for indication. Also, the offset value may be set in association with a QoS (Quality of Service) parameter of packets. For example, the offset value may be determined based on latency, priority, and/or reliability. Also, for example, the offset value may be set in association with system congestion. Also, for example, the offset value may be set based on geographic positional information between the UE groups.

As a result of the above determination (including both cases of applying the offset and of not applying the offset), if the resource set is used by another user apparatus or UE group, the user apparatus 20 may assume that the resource set is not reusable. Upon assuming that the resource set is not reusable, the user apparatus 20 may exclude the resource set from the candidates to be used.

Applying the offset value to the threshold determination enables, for example, when transmitting a packet requiring a low latency, to expand the range of candidate resource sets, and to determine the resource set used for transmission earlier.

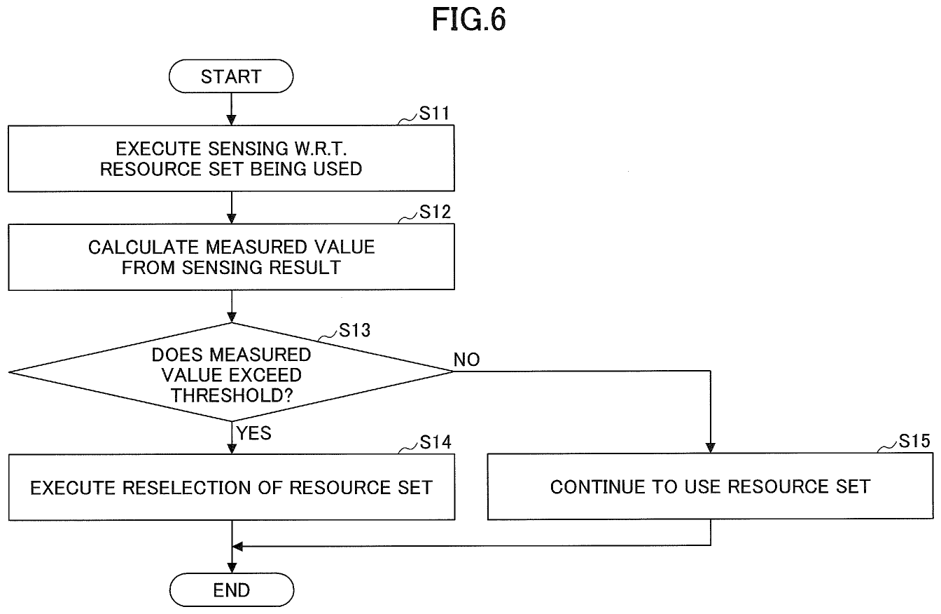

FIG. 6 is a flowchart for describing an example of operations of selecting a resource set according to an embodiment of the present invention. In the following, operations will be described in which a user apparatus 20 belonging to a certain UE group reselects a resource set. The user apparatus 20 may be the header of the UE group, may be a member of the UE group, or may be a user apparatus 20 included in a distributed-type UE group.

At Step S11, the user apparatus 20 performs sensing on a resource set being used. Then, the user apparatus 20 calculates a measured value, such as an RSRP value, from the sensing result (S12). At Step S12, the user apparatus 20 calculates, as the measured value, an instantaneous value, or an average or median value for a period shorter than a period with which the threshold is determined by the method illustrated in FIG. 5. Then, the user apparatus 20 determines whether or not the measured value exceeds the threshold determined as described with FIG. 5 (or falls below the threshold in the case of RSRQ or SINR) (S13). Here, the offset value described above may be applied to the threshold used for determination at Step S13, or the process may be advanced to the next step if the same determination results continue for a predetermined period or number of times. If the measured value exceeds the threshold (or falls below in the case of RSRQ or SINR), the processing advances to Step S14 (YES at S13), or otherwise (NO at S13), advanced to Step S15.

At Step S14, the user apparatus 20 reselects a resource set. On the other hand, at Step S15, the user apparatus 20 continues to use the resource set.

Note that the threshold for determining whether or not a UE group using a resource set exists at a position separated by the average reusable distance or further, and/or the measured values obtained by the sensing, may be reported to the base station apparatus 10 or the user apparatus 20 as the header of the UE group. This reporting may be performed by a normal user apparatus 20, a user apparatus 20 as the header of the UE group, or a user apparatus 20 as a member of the UE group. This reporting may also be performed based on a command from the base station apparatus 10 or the user apparatus 20 as the header of the UE group. This reporting may also be performed periodically or may be triggered by an event. This reporting may also be performed via signaling of a PHY layer or an upper layer. For example, RRC signaling, MACCE (Media Access Control Control Element)/Header, UCI (Uplink Control Information), SCI, or the like may be used.

According to the application examples described above, a user apparatus 20 determines whether another UE group that uses the same resource set exists at a position separated by a reusable distance or further, to make the resources reusable and to improve the use efficiency of the resources. In addition, if the other UE group using the same resource set exists at a position closer than the reusable distance, the user apparatus 20 may also reselect a resource set.

In other words, in direct communication between terminals, it is possible to determine whether or not resources are usable so as to perform efficient communication.

(Apparatus Configuration)

Next, an example of a functional configuration of the base station apparatus 10 and the user apparatus 20 to execute the processes and operations described above, will be described. The base station apparatus 10 and the user apparatus 20 include the functions of implementing the application examples described above. However, each of the base station apparatus 10 and the user apparatus 20 may include only a part of the functions of the application examples.

<Base Station Apparatus 10>

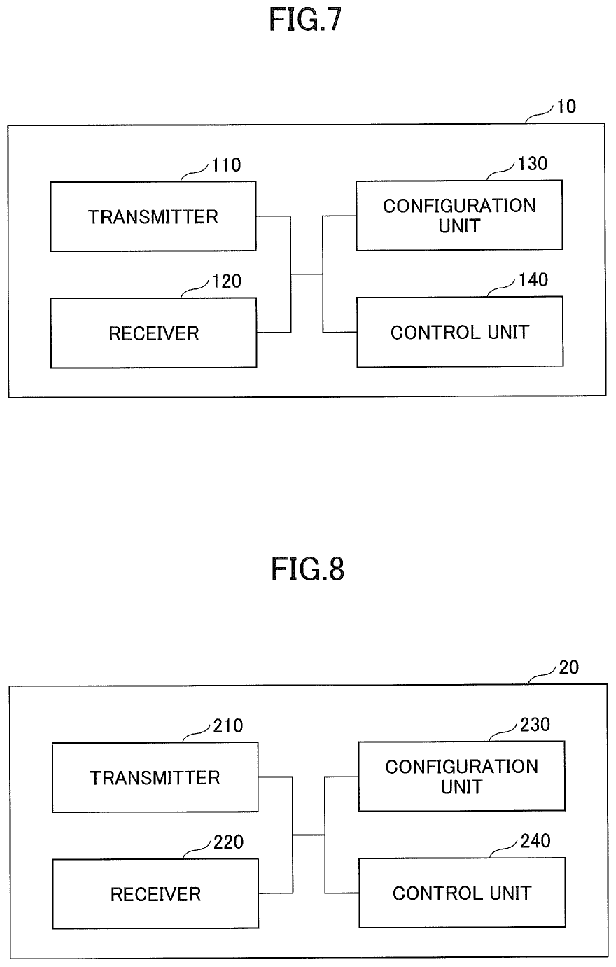

FIG. 7 is a diagram illustrating an example of a functional configuration of the base station apparatus 10. As illustrated in FIG. 7, the base station apparatus 10 includes a transmitter 110, a receiver 120, a configuration unit 130, and a control unit 140. The functional configuration illustrated in FIG. 7 is merely an example. Functional partitioning and names of the functional units may be determined discretionarily as long as operations can be executed according to the embodiments of the present invention.

The transmitter 110 includes a function of generating a signal to be transmitted to a user apparatus 20 and transmitting the signal wirelessly. The receiver 120 includes a function of receiving various signals transmitted from a user apparatus 20 and obtaining information of an upper layer, for example, from the received signal. The transmitter 110 also includes a function of transmitting NR-PSS, NR-SSS, NR-PBCH, DL/UL control signals, DL reference signals, and the like to the user apparatus 20.

The configuration unit 130 stores setting information set in advance and various items of setting information to be transmitted to the user apparatus 20 in a memory device and reads out the setting information from the memory device as needed. The contents of the setting information include, for example, settings of D2D communication and the like.

As described in the application examples, the control unit 140 performs processing related to settings for the user apparatus 20 to perform D2D communication. Also, the control unit 140 transmits scheduling of D2D communication to the user apparatus 20 through the transmitter 110. A functional unit for transmitting signals in the control unit 140 may be included in the transmitter 110, and a functional unit for receiving signals in the control unit 140 may be included in the receiver 120.

<User Apparatus 20>

FIG. 8 is a diagram illustrating an example of a functional configuration of the user apparatus 20. As illustrated in FIG. 8, the user apparatus 20 includes a transmitter 210, a receiver 220, a configuration unit 230, and a control unit 240. The functional configuration illustrated in FIG. 8 is merely an example. Functional partitioning and names of the functional units may be determined discretionarily as long as operations can be executed according to the embodiments of the present invention.

The transmitter 210 generates a transmission signal from transmission data, to transmit the transmission signal wirelessly. The receiver 220 receives various signals wirelessly and obtains a signal of an upper layer from a received signal on the physical layer. Also, the receiver 220 includes a function of receiving NR-PSS, NR-SSS, NR-PBCH, DL/UL/SL control signals, reference signals, or the like transmitted from the base station apparatus 10. Also, for example, the transmitter 210 transmits PSCCH (Physical Sidelink Control Channel), PSSCH (Physical Sidelink Shared Channel), PSDCH (Physical Sidelink Discovery Channel), PSBCH (Physical Sidelink Broadcast Channel), and the like to other user apparatuses 20 as D2D communication, and the receiver 220 receives PSCCH, PSSCH, PSDCH, or PSBCH from the other user apparatuses 20.

The configuration unit 230 stores various items of setting information received by the receiver 220 from the base station apparatus 10 or the user apparatus 20 in a memory device, and reads out the setting information from the memory device as needed. The configuration unit 230 also stores setting information set in advance. The contents of the setting information include, for example, settings of D2D communication and the like.

The control unit 240 controls D2D communication with the other user apparatuses 20 as described in the application examples. Also, the control unit 240 performs processing related to sensing of resources in D2D communication. The control unit 240 may also schedule D2D communication. A functional unit for transmitting signals in the control unit 240 may be included in the transmitter 210, and a functional unit for receiving signals in the control unit 240 may be included in the receiver 220.

(Hardware Configuration)

Block diagrams (FIGS. 7 and 8) used for describing the above embodiments illustrate blocks by units of functions. These functional blocks (components) are implemented by any combination of hardware and/or software. Further, the method of implementing the functional blocks is not limited in particular. In other words, each functional block may be implemented by using one device that is physically or logically coupled, or two or more devices physically or logically separated may be connected directly or indirectly (e.g., by wire or wirelessly) so as to implement the functional block. The functional blocks may be implemented by one or more of the above devices in combination with software.

Functions include, but are not limited to, judgment, decision, determination, calculation, computation, processing, derivation, investigation, search, confirmation, reception, transmission, output, access, resolution, selection, choice, establishment, comparison, assumption, expectation, deeming, broadcasting, notifying, communicating, forwarding, configuring, reconfiguring, allocating, mapping, and assigning. For example, a functional block (component) that implements a function of transmission may be referred to as a transmitting unit or a transmitter. In any case, as described above, implementation methods are not limited in particular.

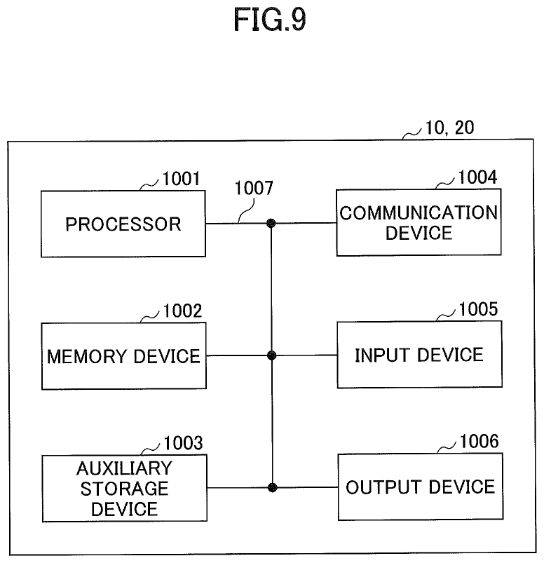

For example, the base station apparatus 10, the user apparatus 20, or the like in an embodiment of the present disclosure may function as a computer that processes a wireless communication method of the present disclosure. FIG. 9 is a diagram illustrating an example of the hardware configuration of the base station apparatus 10 and the user apparatus 20 according to an embodiment of the present disclosure. The base station apparatus 10 and user apparatus 20 described above may be physically configured as a computer device that includes a processor 1001, a memory device 1002, an auxiliary storage device 1003, a communication device 1004, an input device 1005, an output device 1006, and a bus 1007.

Note that in the following description, the term “apparatus” can be read as a circuit, device, unit, or the like. The hardware configuration of the base station apparatus 10 and the user apparatus 20 may be configured to include one or more of the devices illustrated in the figure or may be configured without including some of the devices.

Each function in the base station apparatus 10 and the user apparatus 20 is implemented by loading predetermined software (a program) on the hardware such as the processor 1001 and the memory device 1002 so as to cause the processor 1001 to execute operations, to control communication by the communication device 1004, and to control at least one of reading and writing data in the memory device 1002 and the auxiliary storage device 1003.

The processor 1001 controls the entire computer, for example, by causing an operating system to run. The processor 1001 may be constituted with a central processing unit (CPU) that includes interfaces with peripheral devices, a control unit, an arithmetic unit, registers, and the like. For example, the control unit 140, the control unit 240, and the like described above may be implemented by the processor 1001.

The processor 1001 also reads a program (a program code), a software module, data, and the like from at least one of the auxiliary storage device 1003 and the communication device 1004 to the memory device 1002 to perform various processes in accordance with these. As a program, a program that causes the computer to execute at least some of the operations described in the above embodiments is used. For example, the control unit 140 of the base station apparatus 10 illustrated in FIG. 7 may be implemented by a control program that is stored in the memory device 1002 and executed by the processor 1001. Also, for example, the control unit 240 of the user apparatus 20 illustrated in FIG. 8 may be implemented by a control program that is stored in the memory device 1002 and executed by the processor 1001. Although the various processes described above are assumed to be executed by the single processor 1001, these may be executed simultaneously or sequentially by two or more processors 1001. The processor 1001 may be implemented by one or more chips. Note that the program may be transmitted from the network via a telecommunication line.

The memory device 1002 is a computer-readable recording medium, and may be constituted with, for example, at least one of a ROM (Read-Only Memory), an EPROM (Erasable Programmable ROM), an EEPROM (Electrically Erasable Programmable ROM), a RAM (Random Access Memory), and the like. The memory device 1002 may be referred to as a register, a cache, a main memory (a main memory device), or the like. The memory device 1002 is capable of storing a program (a program code), a software module, and the like that are executable to implement the communication method according to an embodiment of the present disclosure.

The auxiliary storage device 1003 is a computer-readable recording medium and may be constituted with, for example, at least one of an optical disk such as a CD-ROM (Compact Disc ROM), a hard disk drive, a flexible disk, an optical magnetic disk (e.g., a compact disk, a digital versatile disk, a Blu-ray (registered trademark) disk, a smart card, a flash memory (e.g., a card, a stick, and a key drive), a floppy (registered trademark) disk, a magnetic strip, and the like. The auxiliary storage device 1003 may be referred to as an auxiliary storage device. The recording medium described above may be, for example, a database, a server, or any other suitable medium that includes at least one of the memory device 1002 and the auxiliary storage device 1003.

The communication device 1004 is hardware (a transceiver device) for communicating with computers via at least one of a wired network and a wireless network, and is also referred to as, for example, a network device, a network controller, a network card, a communication module, and the like. The communication device 1004 may be configured to include, for example, a high-frequency switch, a duplexer, a filter, a frequency synthesizer, and the like, for example, to implement at least one of a frequency division duplex (FDD) and a time division duplex (TDD). For example, a transmitting and receiving antenna, an amplifier, a transceiver, a transmission line interface, and the like may be implemented by the communication device 1004. The transceiver may be implemented by a transmitter and a receiver that are physically or logically separated.

The input device 1005 is an input device (e.g., a keyboard, a mouse, a microphone, a switch, a button, a sensor, etc.) to receive input from the outside. The output device 1006 is an output device (e.g., a display, a speaker, an LED lamp, etc.) to execute outputting to the outside. Note that the input device 1005 and the output device 1006 may have an integrated configuration (e.g., a touch panel).

Each of the devices such as the processor 1001 and the memory device 1002 is connected via the bus 1007 for communicating information. The bus 1007 may be configured by using a single bus or may be configured by using different buses between specific devices.

The base station apparatus 10 and the user apparatus 20 may also be configured to include hardware such as a microprocessor, a digital signal processor (DSP), an ASIC (Application Specific Integrated Circuit), a PLD (Programmable Logic Device), and an FPGA (Field Programmable Gate Array), and with such hardware, some of or all of the functional blocks may be implemented. For example, the processor 1001 may be implemented by using at least one of these hardware components.

### SUMMARY OF EMBODIMENTS

As described above, according to the embodiments of the present invention, a user apparatus is provided that includes a receiver configured to perform predetermined measurement for a resource set in direct communication between terminals, the resource set having a likelihood of being used by another group to which the user apparatus does not belong; a control unit configured to determine, based on a result of the predetermined measurement, whether an effect from said another group having a likelihood of using the resource set is acceptable; and a transmitter configured to use the resource set to perform transmission to another user apparatus when a determination is made that the effect from said another group that uses the resource set is acceptable.

The above configuration enables the user apparatus 20 to improve the use efficiency of the resources by determining whether another UE group using the same resource set exists within a reusable distance at which the resource set is reusable. In other words, in direct communication between terminals, it is possible to determine whether or not the resources are usable so as to perform efficient communication.

The control unit may determine, based on the result of the predetermined measurement, whether said another group using the resource set exists within a distance at which the resource set is reusable. The configuration enables the user apparatus 20 to improve the use efficiency of the resources by determining whether another UE group using the same resource set exists at a location within a reusable distance at which the resource set is reusable.

The control unit may determine, as a threshold, a value calculated from RSRP (Reference Signal Received Power) sample values obtained by the receiver by measuring a reference signal related to the resource set at a time, by sorting the RSRP sample values in ascending order, and averaging the RSRP sample values within a predetermined ratio from a minimum value of the sorted RSRP sample values, so as to, when an RSRP sample value obtained by the receiver by measuring the reference signal related to the resource set at another time falls below the determined threshold, determine that the effect from said another group having the likelihood of using the resource set is acceptable. The configuration enables the user apparatus 20 to improve the use efficiency of the resources by determining whether another UE group using the same resource set exists at a location within a reusable distance at which the resource set is reusable.

The determination may be performed by adding an offset value to the determined threshold, when a packet requiring a low latency is to be transmitted. The configuration enables the user apparatus 20 to add an offset value in response to a latency request so as to increase the likelihood of detecting a resource set that meets the latency requirement.

The determination may be performed by adding an offset value to the determined threshold, when determining whether to reselect the resource set. The configuration enables the user apparatus 20 to reselect a resource set if another UE group using the same resource set exists within a reusable distance.

The determined threshold may be reported to a base station apparatus or a user apparatus that performs scheduling. The configuration enables the user apparatus 20 to report information on the reusable distance of the resource set to the base station apparatus 10 or another user apparatus 20 to perform scheduling so as to cause the apparatus to perform scheduling with which the use efficiency of the resources is improved.

### SUPPLEMENT TO EMBODIMENTS

As above, the embodiment of the present invention has been described; note that the disclosed invention is not limited to the embodiments, and those skilled in the art would understand various modifications, revisions, alternatives, substitutions, and the like. Although the description has been made by using specific numerical examples to facilitate understanding of the invention, unless otherwise stated, these values are merely examples and any suitable values may be used. Partitioning of the items in the above description is not essential to the present invention, and matters described in two or more items may be used in combination as needed, or a matter described in one item may be applied to another matter described in another item (as long as no inconsistency is introduced). The boundaries of functional units or processing units in the functional block diagrams do not necessarily correspond to the physical boundaries of parts. The operations of the multiple functional units may be performed on a single physical part, or the operation of one functional unit may be performed on multiple physical parts. As for the processing steps described in the embodiments, the order of steps may be exchanged as long as no inconsistency is introduced. Although for the sake of convenience of describing processes, the base station apparatus 10 and the user apparatus 20 have been described by using the functional block diagrams, these apparatuses may be implemented by hardware, software, or a combination of these. The software executed by the processor included in the base station apparatus 10 according to the embodiment of the present invention and the software executed by the processor included in the user apparatus 20 according to the embodiment of the present invention, may be stored, respectively, in a random access memory (RAM), a flash memory, a read-only memory (ROM), an EPROM, an EEPROM, a register, a hard disk (HDD), a removable disk, a CD-ROM, a database, a server, or any other suitable recording medium.

Indication of information is not limited to the aspects and the embodiments described in the present disclosure, and may be done by using other methods. For example, indication of information may be performed by physical layer signaling (e.g., DCI (Downlink Control Information), UCI (Uplink Control Information)), higher layer signaling (e.g., RRC (Radio Resource Control) signaling, MAC (Medium Access Control) signaling, broadcast information (MIB (Master Information Block), SIB (System Information Block)), other signals, or a combination of these. Also, RRC signaling may also be referred to as an RRC message, and may also be, for example, an RRC connection setup message, an RRC connection reconfiguration message, or the like.

The aspects and the embodiments described in the present disclosure may be applied to at least one of systems utilizing LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi) (registered trademark), IEEE 802.16 (WiMAX) (registered trademark), IEEE 802.20, UWB (Ultra-WideBand), Bluetooth (registered trademark), and other suitable systems and next-generation systems extended based on these systems. Also, multiple systems may also be combined (e.g., a combination of at least one of LTE and LTE-A with 5G, etc.) to be applied.

The processing steps, sequences, flowcharts, and the like of the aspects and the embodiments described in the present specification may be reordered as long as no inconsistency is introduced. For example, a method described in the present disclosure presents elements of various steps using an exemplary order, and is not limited to the particular order presented.

A specific operation, as described to be performed by the base station apparatus 10 in the present specification, may be performed by its upper node, depending on circumstances. In a network constituted with one or more network nodes having the base station apparatus 10, it is apparent that various operations performed for communication with the user apparatuses 20 may be performed by at least one of the base station apparatus 10 and other network nodes (for example, an MME or an S-GW may be considered, but not limited to these) other than the base station apparatus 10. In the above description, although a case has been exemplified in which there is a single network node other than the base station apparatus 10, the other network nodes may be a combination of multiple other network nodes (e.g., MME and S-GW).

Information, signals, and the like described in the present disclosure may be output from an upper layer (or a lower layer) to a lower layer (or an upper layer). These may be input and output through multiple network nodes.

Information that has been input or output may be stored in a specific location (e.g., memory) or managed by using a management table. Information to be input or output may be overwritten, updated, or added. Information that has been output may be deleted. Information that has been input may be transmitted to other devices.

A determination in the present disclosure may be performed based on a value (0 or 1) represented by one bit; may be performed based on a Boolean value (true or false); or may be performed based on comparison with a numerical value (e.g., comparison with a predetermined value).

Regardless of whether it is referred to as software, firmware, middleware, a microcode, a hardware description language, or any other name, software should be broadly interpreted to mean instructions, an instruction set, a code, a code segment, a program code, a program, a subprogram, a software module, an application, a software application, a software package, a routine, a subroutine, an object, an executable file, a thread, a procedure, a function, and the like.

Also, software, instructions, information, and the like may also be transmitted and received via a transmission medium. For example, if the software is transmitted from a web site, a server, or another remote source by using at least one of a wired technology (coaxial cable, optical fiber cable, twisted pair, digital subscriber line (DSL: Digital Subscriber Line), etc.) and a wireless technology (infrared, microwave, etc.), at least one of these wired technologies and wireless technologies is included in the definition of a transmission medium.

The information, signals, and the like described in the present disclosure may be represented by using any of a variety of different techniques. For example, data, an instruction, a command, information, a signal, a bit, a symbol, a chip, or the like, which may be mentioned throughout the entire description, may be represented by a voltage, a current, an electromagnetic wave, a magnetic field, magnetic particles, an optical field, or photons, or any combination of these.

A term described in the present disclosure and a term necessary for understanding the present disclosure may be replaced by a term having the same or similar meaning. For example, at least one of a channel and a symbol may be a signal (or signaling). Also, a signal may be a message. Also, a component carrier (CC) may also be referred to as a carrier frequency, a cell, a frequency carrier, or the like.

The terms “system” and “network” as used in the present disclosure may be used interchangeably.

Also, information, a parameter, or the like described in the present disclosure may be represented by using an absolute value, may be represented by using a relative value from a predetermined value, or may be represented by using corresponding other information. For example, a radio resource may be one indicated by an index.

A name used for a parameter described above is not a limited name in any respect. Furthermore, a mathematical expression using such parameters may differ from that explicitly disclosed in the present disclosure. Since various channels (e.g., PUCCH, PDCCH, etc.) and information elements can be identified by all suitable names, the various names assigned to these various channels and information elements are not limited names in any respect.

In the present disclosure, terms such as “base station (BS)”, “radio base station”, “base station apparatus”, “fixed station”, “NodeB”, “eNodeB (eNB)”, “gNodeB (gNB)”, “access point”, “transmission point”, “reception point”, “transmission/reception point”, “cell”, “sector”, “cell”, “cell group”, “carrier”, and “component carrier” may be used interchangeably. A base station may be referred to as another term such as a macro cell, a small cell, a femtocell, a pico cell, or the like.

A base station may accommodate one or more (e.g., three) cells. When a base station accommodates multiple cells, the entire coverage area of the base station may be divided into multiple smaller areas, and each of the smaller areas may also provide communication services by a base station subsystem (e.g., an indoor small base station (RRH: Remote Radio Head)). The term “cell” or “sector” indicates a part or the entirety of the coverage area of at least one of the base stations and base station subsystems providing communications services in this coverage.

In the present disclosure, terms such as “mobile station (MS)”, “user terminal”, “user apparatus (or UE: User Equipment)”, and “terminal” may be used interchangeably.

A mobile station may be referred to by an ordinary skilled person in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any other suitable term.

At least one of the base station and the mobile station may be referred to as a transmission apparatus, a reception apparatus, a communication apparatus, or the like. Note that at least one of the base station and the mobile station may be a device mounted on a mobile body, the mobile body itself, or the like. The mobile body may be a means of transportation (e.g., an automobile, an airplane, etc.), an unmanned mobile body (e.g., a drone, an autonomous vehicle, etc.), or a robot (a manned or unmanned type). Note that at least one of the base station and the mobile station includes an apparatus that does not necessarily move during a communication operation. For example, at least one of the base station and the mobile station may be an IoT (Internet of Things) device such as a sensor.

In addition, the base station in the present disclosure may be read as a user terminal. For example, the aspects and embodiments of the present disclosure may be applied to a configuration in which communication between a base station and a user terminal is replaced by communication between multiple user apparatuses 20 (may be referred to as, for example, D2D (Device-to-Device), V2X (Vehicle-to-Everything)). In this case, a configuration may be adopted in which the functions included in the above base station apparatus 10 are included in the user apparatus 20. In addition, the words “uplink” and “downlink” may be read as a wording corresponding to communication between terminals (for example, “side”). For example, an uplink channel, a downlink channel, or the like may be read as a side channel.

Similarly, a user terminal in the present disclosure may be read as a base station. In this case, a configuration may be adopted in which the functions included in the user terminal described above are included in the base station.

The terms “determination (or determining)” and “decision (or determining)” used in the present disclosure may encompass a wide variety of operations. For example, “determination” and “decision” may include “determination” and “decision” made with judging, calculating, computing, processing, deriving, investigating, searching (looking up, search, inquiry) (e.g., search in a table, a database, or another data structure), or ascertaining. Also, “determination” and “decision” may include “determination” and “decision” made with, for example, receiving (e.g., receiving information), transmitting (e.g., transmitting information), input, output, or accessing (e.g., accessing data in a memory). Also, “determination” and “decision” may include “determination” and “decision” made with resolving, selecting, choosing, establishing, or comparing. In other words, “determination” and “decision” may include “determination” and “decision” made with a certain action. Also, “determination” and “decision” may be read as “assuming”, “expecting”, “considering”, or the like.

The term “connected”, “coupled”, or every variation of these means any direct or indirect connection or coupling between two or more elements, and may encompass a presence of one or more intermediate elements between two elements “connected” or “coupled” to each other. The coupling or connection between elements may be physical, logical, or a combination of these. For example, “connection” may be read as “access”. When used in the present disclosure, such two elements may be considered to be “connected” or “coupled” each other by using at least one of one or more wires, cables, and printed electrical connections, or by using, as several non-restrictive and non-comprehensive examples, electromagnetic energy having a wavelength of a radio frequency domain, a microwave domain, light (both visible and invisible), and the like.

A reference signal may be abbreviated as an RS (Reference Signal) and may be referred to as a pilot depending on the standard to be applied.

A description using “based on” in the present disclosure does not mean “based only on” unless otherwise specified. In other words, “based on” means both “based only on” and “based at least on”.

Any reference to elements specified with the words “first”, “second”, and so on used in the present disclosure does not limit the amount or the sequence of these elements in general. These words may be used in the present disclosure as a convenient way for distinguishing two or more elements among each other. Therefore, a reference to first and second elements does not mean that only the two elements are assumed, or that the first element should be considered to precede the second element in some way.

A “means” in the configuration of each of the devices described above may be replaced by “unit”, “circuit”, “device”, and the like.

In the present disclosure, when the terms “include”, “including”, and variations of these are used, it is intended that these terms are as comprehensive as the term “comprising”. Further, it is intended that the term “or” used in the present disclosure is not an exclusive OR.

A radio frame may be constituted with one or more frames in the time domain. In the time domain, each of the one or more frames may be referred to as a subframe. The subframe may be further constituted with one or more slots in the time domain. The subframe may have a fixed time length (e.g., 1 ms) that does not depend on the numerology.

The numerology may include a communication parameter that is applied to at least one of transmission and reception of a signal or a channel. The numerology may present, for example, at least one of subcarrier spacing (SCS), bandwidth, symbol length, cyclic prefix length, transmission time interval (TTI), number of symbols per TTI, radio frame configuration, specific filtering performed by a transceiver in the frequency domain, specific windowing performed by a transceiver in the time domain, and the like.

A slot may be constituted with, in the time domain, one or more symbols (OFDM (Orthogonal Frequency Division Multiplexing) symbols, SC-FDMA (Single Carrier Frequency Division Multiple Access) symbols) symbols, or the like). A slot may be a unit of time based on the numerology.

A slot may include multiple mini slots. Each mini slot may be constituted with one or more symbols in the time domain. A mini slot may also be referred to as a subslot. A mini slot may be constituted with a fewer number of symbols than a slot. PDSCH (or PUSCH) transmitted with a unit of time greater than a mini slot may also be referred to as PDSCH (or PUSCH) mapping type A. PDSCH (or PUSCH) transmitted by using mini slots may also be referred to as PDSCH (or PUSCH) mapping type B.

Any one of a radio frame, a subframe, a slot, a mini slot, and a symbol represents a unit of time when transmitting a signal. Different names may be used for a radio frame, a subframe, a slot, a mini slot, and a symbol, respectively.

For example, one subframe may be referred to as a transmission time interval (TTI); multiple consecutive subframes may be referred to as a TTI; and one slot or one mini slot may be referred to as a TTI. In other words, at least one of the subframe and the TTI may be a subframe (1 ms) in the existing LTE, may be a period shorter than 1 ms (e.g., 1 to 13 symbols), and may be a period longer than 1 ms. Note that the unit representing TTI may also be referred to as slot, mini slot, or the like.

Here, the TTI means, for example, a minimum unit of time of scheduling in radio communication. For example, in an LTE system, a base station performs scheduling by units of TTIs for each user apparatus 20 to allocate radio resources (such as frequency bandwidth, transmission power, etc., that can be used by each user apparatus 20). However, the definition of a TTI is not limited as such.

TTI may be a unit of time to transmit channel-coded data packets (transport blocks), code blocks, code words, and the like, or may be a unit of processing such as scheduling, link adaptation, and the like. Note that when a TTI is given, a time interval (e.g., the number of symbols) to which transport blocks, code blocks, code words, or the like are actually mapped may be shorter than the TTI.

In the case where one slot or one mini slot is referred to as a TTI, one or more TTIs (i.e., one or more slots or one or more mini slots) may be a minimum unit of time of scheduling. Also, the number of slots (the number of mini slots) constituting the minimum unit of time of scheduling may be controlled.

A TTI having a time length of 1 ms may be referred to as an ordinary TTI (a TTI in LTE Rel.8-12), a normal TTI, a long TTI, an ordinary subframe, a normal subframe, a long subframe, a slot, or the like. A TTI shorter than an ordinary TTI may be referred to as a shortened TTI, a short TTI, a partial TTI (or fractional TTI), a shortened subframe, a short subframe, a mini slot, a subslot, a slot, or the like.

Note that a long TTI (e.g., an ordinary TTI, a subframe, etc.) may be read as a TTI having a time length exceeding 1 ms, and a short TTI (e.g., a shortened TTI, etc.) may be read as a TTI having a TTI length shorter than that of a long TTI and longer than or equal to 1 ms.

A resource block (RB) is a unit of resource allocation in the time domain and in the frequency domain, and may include one or more consecutive subcarriers in the frequency domain. The number of subcarriers included in an RB may be the same regardless of the numerology, which may be, for example, 12. The number of subcarriers included in an RB may be determined based on the numerology.

Also, an RB in the time domain may include one or more symbols, and may have a length of one mini slot, one subframe, or one TTI. One TTI, one subframe, and the like may be constituted with one or more resource blocks, respectively.

Note that one or multiple RB may be referred to as physical resource blocks (PRB), a subcarrier group (SCG), a resource element group (REG), a PRB pair, an RB pair, or the like.

Also, a resource block may be constituted with one or more resource elements (RE). For example, one RE may be a radio resource area of one subcarrier and one symbol.

A bandwidth part (BWP, which may be referred to as a partial bandwidth, etc.) may represent a subset of consecutive common RB (common resource blocks) in terms of certain numerology in a certain carrier. Here, a common RB may be identified by an RB index with reference to a common reference point in the carrier. PRB may be defined in a BWP to be numbered in the BWP.

BWP may include a BWP for UL (UL BWP) and a BWP for DL (DL BWP). For a UE, one or more BWPs may be set in one carrier.

At least one of set BWPs may be active, and a UE does not need to assume transmission and reception of a predetermined signal/channel outside the active BWP. Note that “cell”, “carrier”, or the like in the present disclosure may be read as “BWP”.

The structures of radio frames, subframes, slots, mini slots, symbols, and the like described above are merely examples. For example, configurations of the number of subframes included in a radio frame; the number of slots per subframe or radio frame; the number of mini slots included in a slot; the number of symbols and RB included in a slot or a mini slot; the number of subcarriers included in an RB; the number of symbols included in a TTI; the symbol length; the length of cyclic prefix (CP); and the like, can be changed in various ways.

In the present disclosure, in the case where an article, for example, “a”, “an”, or “the” in English, is added by translation, the present disclosure may include the plural form of the noun following these articles.

In the present disclosure, the term “A and B are different” may mean “A and B are different from each other”. The term may mean “A and B are different from C, respectively”. Terms such as “separate” and “coupled” may also be interpreted in the same way as “different”.

The aspects and embodiments described in the present disclosure may be used individually, may be combined to be used, or may be switched during execution to be used. Indication of predetermined information (e.g., indication of “being X”) is not limited to an explicit indication, and may be done implicitly (e.g., by not indicating the predetermined information).

In the present disclosure, the UE group is an example of a group. The header is an example of the user apparatus 20 that performs scheduling. Sensing is an example of predetermined measurement.

As above, the present disclosure has been described in detail; note that it is apparent to those skilled in the art that the disclosure is not limited to the embodiments described in the present disclosure. The present disclosure may be implemented as a modified and changed aspect without deviating from the purpose and scope of the present disclosure defined by the description of the claims. Accordingly, the description of the present disclosure is intended for illustrative purposes and does not have any restrictive meaning with respect to the present disclosure.

### DESCRIPTION OF REFERENCE SIGNS

10 base station apparatus
110 transmitter
120 receiver
130 configuration unit
140 control unit
20 user apparatus
210 transmitter
220 receiver
230 configuration unit
240 control unit
1001 processor
1002 memory device
1003 auxiliary storage device
1004 communication device
1005 input device
1006 output device

1. A user apparatus comprising:
a receiver configured to perform predetermined measurement for a resource set in direct communication between terminals, the resource set having a likelihood of being used by another group to which the user apparatus does not belong;
a control unit configured to determine, based on a result of the predetermined measurement, whether an effect from said another group having a likelihood of using the resource set is acceptable; and
a transmitter configured to use the resource set to perform transmission to another user apparatus when a determination is made that the effect from said another group that uses the resource set is acceptable.

2. The user apparatus as claimed in claim 1, wherein the control unit determines, based on the result of the predetermined measurement, whether said another group using the resource set exists within a distance at which the resource set is reusable.

3. The user apparatus as claimed in claim 1, wherein the control unit:
determines, as a threshold, a value calculated from RSRP (Reference Signal Received Power) sample values obtained by the receiver by measuring a reference signal related to the resource set at a time, by sorting the RSRP sample values in ascending order, and averaging the RSRP sample values within a predetermined ratio from a minimum value of the sorted RSRP sample values; and
when an RSRP sample value obtained by the receiver by measuring the reference signal related to the resource set at another time falls below the determined threshold, determines that the effect from said another group having the likelihood of using the resource set is acceptable.

4. The user apparatus as claimed in claim 3, wherein the determination is performed by adding an offset value to the determined threshold when a packet requiring a low latency is to be transmitted.

5. The user apparatus as claimed in claim 3, wherein the determination is performed by adding an offset value to the determined threshold when determining whether to reselect the resource set.

6. The user apparatus as claimed in claim 3, wherein the determined threshold is reported to a base station apparatus or is reported to a user apparatus that performs scheduling.
